(19) United States
(12) Patent Application Publication
(10) Pub. No.: US 2020/0036592 A1
(43) Pub. Date: Jan. 30, 2020

(54) USER PROFILE ENVIRONMENT-AUTOMATION CONFIGURATIONS

(71) Applicant: Hewlett Packard Enterprise Development LP, Houston, TX (US)

(72) Inventor: Ahmad Kholaif, Santa Clara, CA (US)

(21) Appl. No.: 16/048,538

(22) Filed: Jul. 30, 2018

(51) Int. Cl. H04L 12/24; H04W 48/04; H04W 64/00; H04W 8/22; H04L 29/08

(52) U.S. Cl. CPC H04L 41/0886; H04W 48/04; H04L 67/306; H04W 8/22; H04L 41/12; H04W 64/003

(57) ABSTRACT

An example of a system may include a processing resource and a computing device comprising instructions executable by the processing resource to determine, from a network management frame received by a network device from a client device, a user profile corresponding to the client device; and configure, responsive to detecting a motion with the network device, a setting of an environment-automation device connected to the computing network based on the determined user profile.

### BACKGROUND

Computing networks and constituent networking devices are ubiquitous in our homes, offices, and other environments. Such computing networks may be utilized to communicate with environment-automation devices that execute actions in response to user input in order to regulate aspects of the environment. For example, environment-automation devices may be associated with computing networks and respond to user commands communicated over the computing networks.

### BRIEF DESCRIPTION OF THE DRAWINGS

FIG. 1 illustrates an example of a system for user profile environment-automation configurations consistent with the disclosure.

FIG. 2A illustrates a network device for user profile environment-automation configurations consistent with the disclosure.

FIG. 2B illustrates a network device for user profile environment-automation configurations consistent with the disclosure.

FIG. 3 illustrates a diagram of a processing resource and a non-transitory machine-readable medium for user profile environment-automation configurations consistent with the disclosure.

FIG. 4 illustrates a diagram of a method for user profile environment-automation configurations consistent with the disclosure.

### DETAILED DESCRIPTION

As used herein, a network device may include a computing device that is adapted to transmit and/or receive signaling and to process information within such signaling across a network. For example, a network device may include a network controller, an access point, a client device, and/or a data transfer device.

As used herein, a client device may include a computing device including hardware and/or a combination of hardware and instructions executable by the hardware to access and/or communicate with the network and/or other network devices on the network. For example, a client device may include any data processing equipment such as a computer, laptop, cellular phone, smart phone, personal digital assistant, tablet devices, smart devices, wearable smart devices, smart watch, smart glasses, augmented reality devices, virtual reality devices, etc.

As used herein, an Access Point (AP) may include a computing device including hardware and/or a combination of hardware and instructions executable by the hardware to operate as a transmitter and/or a receiver of signals between a client device, other access points, a controller, and/or other network devices on the network. In some examples, an AP may act as a transmitter and/or receiver of wireless radio signals for any known or convenient wireless access technology which may later become known. While the term AP may include network devices that transmit and/or receive IEEE 802.11-based Wi-Fi signals, AP is not intended to be limited to IEEE 802.11-based APs.

APs may generally function as an electronic device that is adapted to allow wireless computing devices, such as client devices, to connect to a wired network via various communications standards. An AP can include a processing resource, memory, and/or input/output interfaces, including wired network interfaces such as IEEE 802.3 Ethernet interfaces, as well as wireless network interfaces such as IEEE 802.11 Wi-Fi interfaces and/or 802.15 interfaces, although examples of the disclosure are not limited to such interfaces. An AP can include a memory resource, including read-write memory, and a hierarchy of persistent memory such as ROM, EPROM, and Flash memory.

As used herein, a data transfer device may include a computing device including hardware and/or a combination of hardware and instructions executable by the hardware to operate as an intermediary device for coordinating the transfer of data between network device across a network and/or to other networks. For example, a data transfer device may include network switches, routers, controllers, etc.

As used herein, a network controller may include a computing device including hardware and/or a combination of hardware and instructions executable by the hardware to manage APs and data transfer among the APs in the network. A controller may include a wireless local area network (WLAN) controller. The WLAN controller may coordinate the operation of and/or communication between APs in the network to mitigate interference between wireless APs, to perform load balancing, to provide fail over redundancy, to retrieve upgrades, and/or to send updates to the APs, etc. In some examples, the APs may connect, via a wired connection and/or wirelessly, to a controller and the controller may connect to a wireless network. In some examples, the controller may be AP-based controllers that are integrated with the AP.

As used herein, an environment-automation device may include a computing device that automates the control and/or modification of an environment. For example, an environmental-automation device may include a device that automates the control and/or modification of environmental conditions such as heating, ventilation, air conditioning, lighting, ambiance, sounds, announcements, security, entertainment, food preparation, household tasks, etc. An environment-automation device may perform actions associated with controlling or modifying the environmental conditions based on user commands or data received via a computing network that the environment-automation device is in communication with.

As used herein, environment-automation devices may include an Internet of things (IoT) smart home/smart office/smart building device. An IoT device may include a non-general-purpose computing device. That is, the IoT device may be a specific-purpose computing device. For example, the IoT device may include a device, home appliance, vehicle, object, etc. that may include embedded electronics, a hardware processor, instructions executable by the hardware processor, sensors, actuators, and/or displays. Some examples of IoT devices may include smart speakers, smart thermostats, smart lightbulbs, smart locks, smart wall sockets, smart cameras, smart toys, smart remotes, smart kitchen appliances, smart watches, casting devices, smart light switches, biomedical monitors, smart entertainment devices, virtual personal assistant devices, etc. The IoT devices may include the components to achieve network connectivity with a computing network. As such, IoT devices may establish communication with other IoT devices, other computing devices, servers, remote services, network devices, access points, network controllers and/or other network appliances and allow for the exchange of data.

The environment-automation device may perform actions to modify the environmental conditions in response to commands manually entered by a user, sensor data form sensors integrated into the device, and/or commands received from a user over a computing network. In examples, achieving a user-specific desired environment condition of for a particular user may involve manual configuration by the user to specify the desired condition (e.g., manually setting a smart thermostat control interface to a desired temperature, manually selecting a desired lighting condition on a smart lighting control interface, manually selecting a particular song or greeting to play on a smart entertainment device interface, etc.). Accordingly, environment-automation devices involving such manual configuration may lack a fully automated functioning, instead involving manual configuration by a user.

In some prior systems, sensors integrated with the environment-automation device may be utilized to trigger actions of the environment-automation device. For example, a smart thermostat may utilize integrated motion sensors to determine if a house is occupied and trigger a home or away mode. Environment-automation devices including such sensors may be more expensive, include additional computing resources to process the signals, and/or consume more power than environment-automation devices without such sensors. Additionally, environment-automation devices with such sensors may be unable to discriminate between individual users. As such, achieving a user-specific desired environment condition for a particular user may involve manual configuration by the user to specify the desired condition. Accordingly, environment-automation devices involving such manual configuration may lack a fully automated functioning, instead involving manual configuration by a user.

In contrast, examples of the present disclosure may utilize a system to configure settings of an environment-automation device based on a user profile. The system may include a processing resource and a computing device. The computing device may include instructions executable by the processing resource to determine, from a network management frame received by a network device from a client device, a user profile corresponding to the client device. The computing device may include instructions executable by the processing resource to configure, responsive to detecting a motion with the network device, a setting of an environment-automation device connected to the computing network based on the determined user profile. As such, the system may configure settings of the environment-automation device without manual interaction by the user. Further, examples of the present disclosure may be utilized to automatically orchestrate the operations of environment-automation devices in a manner that reduces power consumption, reduces computational resource demand, and/or reduces the presences of multiple duplicative sensor arrays in an environment and/or on an environment-automation device while additionally providing a greater precision and/or customization in environmental-automation than prior systems. Additionally, network resources may be preserved by avoiding associating and/or authenticating a client device 104 to the network while still allowing the configuration of settings of the environment-automation device 106.

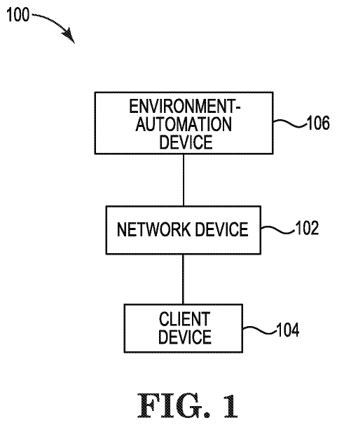

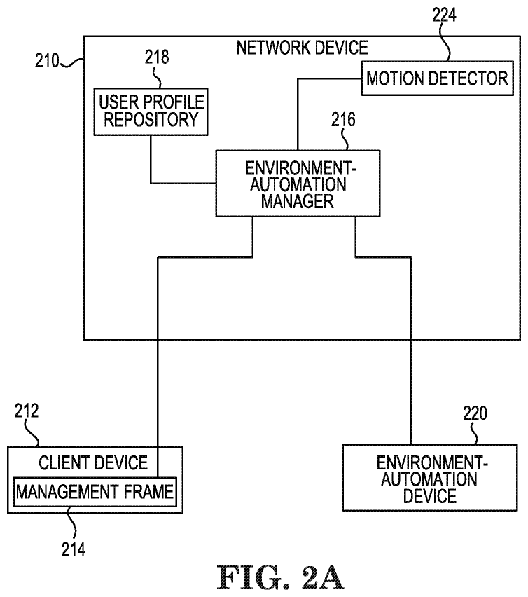

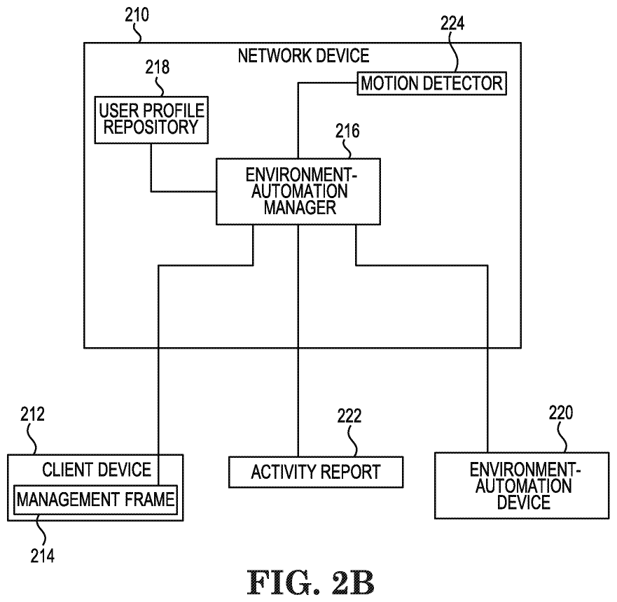

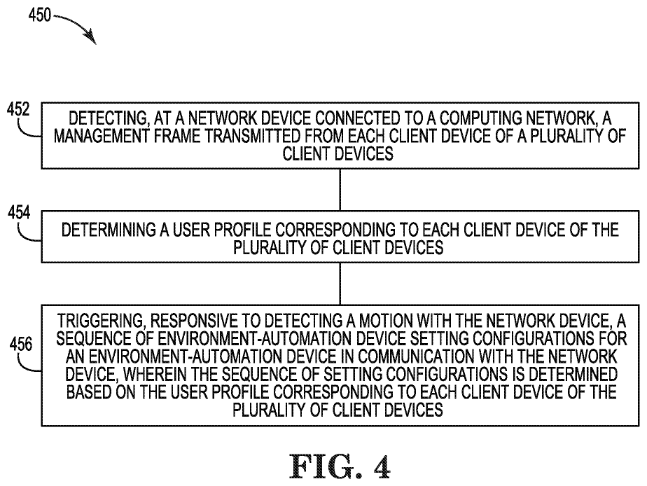

FIG. 1 illustrates an example of a system 100 for user profile environment-automation configurations consistent with the disclosure. The system 100 is not limited to a particular example described herein and may include additional components and/or functionalities such as those described with regard to the network device 210 of FIG. 2A, the network device 210 of FIG. 2B, the non-transitory machine-readable medium 334, and the method 450 described in FIG. 4.

The system 100 may include a network device 102. The network device 102 may be connected to a computing network. For example, the network device 102 may be connected to a local area network providing network coverage in and/or around an environment such as home, an office building, a vehicle, an outdoor space, etc.

In some examples, the network device 102 may be an access point. For example, the network device 102 may be a wireless access point. The network device 102 may be in communication with a wired computing network. The network device 102 may establish a wireless local area network by transmitting and receiving radio signals to wirelessly communicate data to other access points, to a network controller, to client devices, etc. The network device 102 may utilize Wi-Fi transceivers, Bluetooth transceivers, Bluetooth Low Energy (BLE) transceivers, ZigBee transceivers, etc. to wirelessly communicate the data.

The system 100 may include an environment-automation device 106. The environment automation device 106 may include a computing device that is in communication with the computing network that the network device 102 is connected to, is associated to the network device 102, and/or is associated to another network device in the computing network that the network device 102 is connected to. That is, the environment-automation device 106 and the network device 102 may be connected to and/or in communication with the same computing network. For example, the network device 102 may be a wireless access point for a wireless local area network of a building and the environment-automation device 106 may be a computing device such as a smart thermostat for the building and may be connected to the wireless local area network of a building. In some examples, environment-automation device 106 may be a component or module of a network device 102.

The environment-automation device 106 may send and/or receive data over the computing network to which the network device 102 is connected. The environment-automation device 106 may send data to or receive data from the network device 102. The network device 102 and the environment-automation device 106 may exchange data directly with one another and/or they may exchange data across the computing network utilizing other network device intermediaries.

The environment-automation device 106 may include a computing device that automates the control and/or modification of environmental conditions such as heating, ventilation, air conditioning, lighting, ambiance, sounds, announcements, security, entertainment, food preparation, household tasks, etc. For example, an environment-automation device 106 may include an Internet of things (IoT) smart home/smart office/smart building device. For example, the environment-automation device 106 may include a device, home appliance, vehicle, object, etc. that may include embedded electronics, a hardware processor, instructions executable by the hardware processor, sensors, actuators, and/or displays. Some examples of environment-automation device 106 may include smart speakers, smart thermostats, smart lightbulbs, smart locks, smart wall sockets, smart cameras, smart toys, smart remotes, smart kitchen appliances, smart watches, casting devices, smart light switches, biomedical monitors, smart entertainment devices, virtual personal assistant devices, etc.

The environment-automation device 106 may perform actions to modify the environmental conditions in response to commands. For example, an environment-automation device 106 may control or modify temperature, humidity, airflow, air conditioning, heating, etc. of a portion or a plurality of portions of the environment. The environment-automation device 106 may control or modify ambiance, lighting, scents, window shade positioning, music, audio, announcements, audio or visual greetings, television tuning or displays, etc. of a portion or a plurality of portions of the environment. The environment-automation device 106 may control or modify security settings, door locks, door openers or closers, IP security cameras, audio recorders, alarms, etc. The environment-automation device 106 may control or modify appliance operation. The environment-automation device 106 may control or modify virtual assistant operation.

The system 100 may include a client device 104. The client device 104 may include any data processing equipment such as a computer, laptop, cellular phone, smart phone, personal digital assistant, tablet devices, smart devices, wearable smart devices, smart watch, smart glasses, augmented reality devices, virtual reality devices, etc.

The client device 104 may include a computing device including hardware and/or a combination of hardware and instructions executable by the hardware to access and/or communicate with the network and/or other network devices on the network. For example, the client device 104 may include a radio to wirelessly communicate data to and/or from network device 102 and/or the computing network to which the network device 102 is connected. For example, the client device 104 may utilize a radio and Wi-Fi, ZigBee, Bluetooth, BLE, WiMax, etc. wireless communication technologies to communicate data to and/or from network device 102 and/or the computing network to which the network device 102 is connected.

The client device 104 may utilize data frames of various types for data communication with a network device 102 and/or the computing network to which the network device 102 is connected. The various frame types utilized by the client device 104 may be frames defined by corresponding standards such as IEEE 802.11 standard, IEEE 802.15 standards, IEEE 802.16 standards, etc. although examples of the disclosure are not limited to such standards.

In some examples, the client device 104 may utilize management frames in order to establish and/or maintain wireless communication with a network device 102 and/or the computing network to which the network device 102 is connected. As such, the network device 102 may utilize management frames in order to establish and/or maintain wireless communication with a client device 104. A management frame may include a MAC address and/or a signal strength indicator.

As used herein, a management frame may include an authentication frame. An authentication may include process whereby the network device 102 accepts or rejects the identity of radio network interface cards (NICs) of the client device 102. The NIC may begin the process by sending an authentication frame containing its identity to the network device 102. The management frame may also include a deauthentication frame sent to terminate secure communications.

The management frame may include an association request frame. A NIC of the client device 104 may begin an association process by sending an association request to the network device 102. This frame may carry information about the NIC (e.g., supported data rates) and the SSID of the network it wishes to associate with. After receiving the association request, the network device 102 may consider associating with the NIC, and (if accepted) reserves memory space and establishes an association ID for the NIC. The management frame may include a reassociation request frame if a radio NIC roams away from the currently associated network device 102 and finds another network device having a stronger beacon signal. The new network device then coordinates the forwarding of data frames that may still be in the buffer of the previous network device 102 waiting for transmission to the radio NIC. The management frame may include a disassociation frame when the client device 104 wishes to terminate an association. The NIC of the client device 104 may send the disassociation frame to alert the network device 102 that the NIC is powering off and the network device 102 may relinquish memory allocations and remove the radio NIC from the association table.

The management frame may include a probe request frame. A client device 104 may send a probe request frame to obtain information from another client device 104 and/or a network device 102. For example, the client device 104 may send a probe request to determine which access points are within range of the client device 104. The probe request may occur periodically and without user instigation whenever the corresponding radio of the client device 104 is active. For example, when a Wi-Fi setting of a client device 104 is activated, the Wi-Fi radio may periodically send, without human interaction, probe request frames looking for an access point of a Wi-Fi network to establish a connection with. The management frame may also include a probe response claim containing capability information, supported data rates, etc. sent in response to receiving a probe request frame.

As described above, the management frames communicated from a client device 104 to a network device 104 may include information about the client device 104. The management frames may specify a MAC address of the client device 104, a signal strength indicator of the client device 104, an indication of the device type of the client device 104 (e.g., smartphone device, laptop device, tablet device, wearable device, etc.).

The system 100 may also include a processing resource. The processing resource may be a processing resource of the network device 102, a processing resource assigned to the network device 102, and/or a processing device of another network device. The system 100 may include instructions executable by the processing resource. The instructions may be stored on a non-transitory machine-readable memory of the network device 102, assigned to the network device 102, and/or accessible by the network device 102. The instructions may be executable by the processing resource to perform various functions related to configuring a setting of an environment-automation device.

For example, the system 100 may include instructions executable by the processing resource to determine a user profile associated with a client device 104. For example, the user profile associated with a particular client device 104 may be determined from a network management frame sent from that client device 104. The network management frame may indicate a unique identifier assigned to a client device 104 that may be extracted from the management frame and referenced against an association between unique identifiers and their corresponding user profiles.

A user profile may include a preference of a condition of an environment, such as the temperature, the volume of sounds played, the sounds played, the lighting, the ambiance, the enabled/disabled features of the environment, etc. A user profile may specify settings, a sequence of settings, actions, a sequence of actions, etc. of an environment-automation device 106. For example, a profile may specify that a smart lighting system should be set to a particular brightness, a temperature of a smart thermostat should be set to seventy degrees Fahrenheit, a voice greeting stating “Welcome home, John Smith!” should be played on a smart audio/visual system, and relaxing music should be played on the smart audio/visual system after the greeting.

The user profiles may specify different settings, sequence of settings, actions, sequence of actions, etc. of an environment-automation device 106 based on the time of day, the day of the week, the month, etc. Additionally, the user profiles may specify different settings, sequence of settings, actions, sequence of actions, etc. of an environment-automation device 106 based on other circumstances such as the user being present in building, user being present in a particular room of the building, user returning to the room or building after an absence, user leaving the room or building, etc.

Furthermore, a user profile may correspond to a plurality of client devices of different types. For example, a user profile may correspond to a single user's smartphone, tablet, smartwatch, etc. The user profile may specify different settings, sequences of settings, actions, sequence of actions, etc. for each device type. For example, an indication in a management frame that the sending device is a smartphone may cause a first subset of settings to be configured, an indication in a management frame that the sending device is a tablet may cause a second subset of settings to be configured, and an indication in a management frame that the sending device is a smartwatch may cause a third subset of settings to be configured.

User profiles may be specific to a particular person, a particular device, a particular category of person, etc. For example, a user profile may be unique to the particular person “John Smith.” In other examples, the user profile may correspond to unknown or unregistered people or users. In some examples the user profile may correspond to categories of people such as “employee,” “owner,” “guest,” “authorized visitor, “unauthorized visitor,” “intruder,” “customer,” “worker,” “cleaning staff,” “child,” “adult,” etc.

The preferences, settings, actions, etc. saved in a user profile may be populated a variety of ways. For example, a human user may construct the user profile for themselves, for other users, for categories of users, etc. Additionally, preconfigured generic templates of preferences, settings, actions, etc. may be applied. Further, historical settings configurations performed by a user associated with the user profile may be utilized to develop the user profiles.

For example, an owner of a home network may create and configure a user profile for himself, one for each of his children, and one for his spouse. In another example, a network administrator for a business network may create and configure a user profile for individuals in the company and for categories of users such as employee and customer. In another example, the profile for an owner of a home network may be created from an analysis of the historical temperature settings he has entered to a smart thermostat.

The user profile associated with a particular client device 104 may be determined from a network management frame sent from that client device 104. As described above, the client device 104 may transmit network management frames in the course of operation and without human intervention. For example, when the radio of the client device 104 is active then the client device may periodically send management frames such as probe request frames to identify access points that are within the range of the client device 104. As described above, these management frames may include data uniquely identifying the client device. For example, the management frames may include the MAC address assigned to the client device 104. The management frames may also identify a signal strength identifier of the radio signal of the client device 104, an identification of a type of client device, and/or other information identifying the client device 104 and/or its characteristics.

The management frames that are received by the network device 102 may be utilized to determine a user profile associated with a client device 104. For example, data included in the management frames that may be utilized to uniquely identify the client device 104 may be utilized to identify a user profile associated with a client device 104.

For example, as described above a MAC address uniquely assigned to a client device 104 may be communicated in a management frame form the client device 104. This MAC address may be extracted from the management frame received at the network device 102. The MAC address may then be referenced against a data structure storing associations between MAC addresses and their corresponding user profiles. For example, a data structure may include a MAC address or MAC addresses that correspond to a user profile. The correspondence between MAC addresses and user profiles may be configured by a human user and/or may be determined based on applications or profiles operating on particular client devices.

For example, a user of a client device 104 and/or an administrator or owner of a computing network may register their own or other's MAC addresses and/or client devices with a user profile and store the correspondence. The registration may occur prior to receiving the management frame from the client device 104, at the time that a first management frame is received from the client device 104, and/or after the time that a first management frame is received from the client device 104. In this manner, a catalog of associations between MAC addresses user profiles may be created and stored. As described above, a guest or unknown user profile is contemplated whereby previously unregistered or unrecognized MAC addresses may be registered to such a user profile until a time where they are assigned to a different user identity.

The system 100 may include instructions executable by the processing resource to configure a setting of an environment-automation device 106. The setting may be configured based on the settings, a sequence of settings, an action, a sequence of actions for an environment-automation device 106 included in the user profile corresponding to the client device 104.

In some examples, the network device 102, may identify the user profile from the data included in the management frames that uniquely identifies the client device 104 and/or may issue commands to the environment-automation device 106 based on the user profile. In some examples, a different network device or a different client device on the computing network may identify the user profile from the data included in the management frames that uniquely identifies the client device 104 and/or may issue commands to the environment-automation device 106 based on the user profile. In some examples, the environment-automation device 106 may identify the user profile from the data included in the management frames that uniquely identifies the client device 104 and/or may execute actions or configure settings based on the user profile. In some examples, the identification of the user profiles and the configuration of the settings may be split among the network device 102, a different network device or a different client device on the computing network, and an environment-automation device 106.

The settings or actions of the environment-automation device 106 may be configured according to a setting or action configuration preference specified in the user profile determined to correspond to the client device 104. For example, a first setting of the environment-automation device 106 may be adjusted to a second setting of the environment-automation device 106 to match a setting configuration specified in the user profile corresponding to the client device 104. For example, a temperature setting of a smart thermostat may be configured from seventy-three degrees Fahrenheit to seventy degrees Fahrenheit based on a seventy degrees Fahrenheit temperature preference being specified within a user profile determined to be associated with the client device 104 from a MAC address included in a management frame sent from the client device 104.

As described above, the user profile may be determined from the management frame received at the network device 102 from the client device 104. In some examples, the management frame may be received at the network device 102 from the client device 104 prior to an association and/or authentication of the client device 104 to the network device 102 and/or the computing network. That is, rather than associating and/or authenticating the client device 104 to the network device 102 and/or the computing network to which the network device 102 is connected before configuring settings of an environment-automation device 106, a setting of environment-automation device 106 may be configured in advance of or without the additional steps of associating and/or authenticating. In this manner, settings of environment-automation device 106 may be configured without giving the client device 104 access to the computing network. Accordingly, network security may be preserved while still allowing for configuring settings of the environment-automation device 106. Additionally, network resources may be preserved by avoiding associating and/or authenticating a client device 104 to the network while still allowing the configuration of settings of the environment-automation device 106. Further, a user of a client device 104 may, without manual intervention, have an environment acclimated to a set of predefined preferences by simply passing within radio range of the network device 102 in advance of any association or authentication actions.

In some examples, the network device 102 may include and/or be in communication with a motion detector. In some examples, the motion detector may be an integrated component of the network device 102. That is, the network device 102 may include, in its body, a motion detecting sensor. Since a network device 102 and/or a plurality of network devices may be present in an environment in order to provide access to a computing network (e.g., providing a radio communication for a wireless local area network), the network device 102 with the integrated motion detector may monitor the environment for motion. The motion detector may detect motion in the direct vicinity of the network device 102 and/or in a portion of the environment visible to the motion detector. Premature or unwanted configuration of settings of the environment-automation device 106 may be avoided utilizing feedback from the motion detector.

For example, the configuration of the setting of the environment-automation device 106 may be triggered responsive to the detection of a motion by a motion detector (e.g., the motion detecting portion of the network device 102). In an example, a user, John Smith, may drive into his driveway. A network management frame may be sent from his smartphone may be detected by the network device 102 connected to his home network as he approaches the house. His user profile may be determined from the network management frame sent from his smartphone. In this example, the configuration settings in the user profile may include playing a greeting on the smart home audio system of “Welcome Home, John Smith!,” followed by playing some relaxing music on the smart home audio system, and adjusting the smart lighting from an off position to an on position of a particular brightness setting. However, John Smith may not come into his home immediately and may instead engage in a conversation with a neighbor and retrieve his mail from his mailbox. During this time, the configuration of the settings of the corresponding environment-automation devices may be delayed. However, once motion is detected by a motion detecting portion of the network device 102 at an entrance of his home, the settings of the corresponding environment-automation devices may then be configured so that the greeting is played, the music is started, and the lighting is adjusted.

Additional mechanisms may be utilized to avoid premature or unwanted configuration of settings of the environment-automation device 106. For example, a dwell time of a signal received from the client device 104, a BLE signal received from the client device 104, a time of flight of a signal received from the client device 104, a triangulation of the location of the client device 104 performed by a number of network devices, etc. may be utilized to determine a location of the client device 104 within the environment and/or relative to other devices connected to the computing network. Such mechanisms may allow for the identification of the location of the client device 104 within the environment with greater specificity than simply detecting that the client device 104 is within range of the network device 102 since a management frame was received from the client device 104. The environment-automation device 106 setting configurations may be triggered in response to the client device 104 being detected in a particular location of the environment such that the timing of the actions of the environment-automation device 106 coincides with the timing of an arrival of the client device 104 at a particular location.

FIG. 2A illustrates a network device 210 for user profile environment-automation configurations consistent with the disclosure. The network device 210 is not limited to a particular example described herein and may include additional components and/or functionalities such as those described with regard to the system 100 described in FIG. 1, the network device 210 of FIG. 2B, the non-transitory machine-readable medium 334, and the method 450 described in FIG. 4.

The network device 210 may include an access point connected to a computing network. The network device 210 may communicate back and forth with client devices using wireless radio communication.

The network device 210 may include a processing resource. The network device 210 may include a memory resource. For example, the network device 210 may include a non-transitory machine-readable medium storing instructions executable by the processing resource to perform functions corresponding to user profile environment-automation configurations.

The network device 210 may create a wireless local area network in an environment such as a home, office building, vehicle, outdoor space, etc. The network device 210 may be connected to a wired router, switch, or hub via a cabled (e.g., Ethernet cable) connection and may project signals such as Wi-Fi, BLE, Bluetooth, ZigBee, etc. to designated areas within the environment.

A client device 212 may pass within radio signal range to the area of the environment receiving WLAN coverage by the network device 210. In examples where the client device 212 has an onboard wireless transceiver activated (e.g., Wi-Fi radio activated on a smartphone, BLE radio activated on a smartphone, Bluetooth radio activated on a smartphone, ZigBee radio activated on a smartphone, etc.), the client device 212 may be transmitting management frames 214. For example, the client device 212 may be transmitting probe request frames searching for a network device 102 to associate with. Once the client device 212 has received a response to a probe request and identified the network device 102, the client device 212 may begin transmitting a management frame 214 such as an association request frame to the network device 210.

Management frames 214 may include data about the client device 212. For example, the management frames 214 may include data that uniquely identifies the client device 212 and/or the characteristics thereof. In an example, the management frame 214 may include the MAC address assigned to the client device 212.

The network device 210 may include an environment-automation manager 216. An environment-automation manager 216 may include instructions executable by a processing resource to perform functions corresponding to user profile environment-automation configurations. Although illustrated as being located on the network device 210, the instructions of the environment-automation manager 216 may be located at and/or executed from locations remote from the network device 210.

The environment-automation manager 216 may analyze the management frames 214 that it receives, and extract and log the data about the client device 212 in the management frame 214. The environment-automation manager 216 may, for example, extract and log the MAC address of a client device 212 from a management frame 214 sent from the client device 212.

The environment-automation manager 216 may reference the data from the management frame 214 about the client device 212 against a user profile repository 218. A user profile repository 218 may include a profile of settings to be adjusted or actions to be performed in an environment corresponding to the computing network to which the network device 210 is connected. Each user profile in the user profile repository 218 may be configured and stored in advance of the network device 210 receiving the management frame 214. For example, a user may configure his profile or the profile of another. In some examples, a user may utilize a user interface to input the settings or actions, and the sequence thereof, into a profile to be saved in the user profile repository. In some examples, when a user makes an adjustment to a setting or requests an action of an environment-automation device 220, the user may be queried whether they would like to add the adjustment to their user profile or the user profile of another. In some examples, repeated adjustments to settings or requests of actions may be automatically added to the user profile without human intervention. In some examples, such as with a home computing network, a user may be able to adjust their own profile. In some examples, such as in a business computing network profile changes may involve administrative approval or be controlled by a network administrator.

The settings to be adjusted or the actions to be performed may be specific, such as send a command to adjust a smart thermostat to seventy degrees Fahrenheit. In some examples, the settings to be adjusted or the actions to be performed may be more generic such as user prefers temperature between seventy and seventy-three degrees Fahrenheit and the environment-automation manager 216 and/or the environment-automation device 220 may include the computing intelligence to compare the settings of the smart thermostat to the range and determine if adjustments or actions are needed to reach the range.

The environment-automation manager 216 may reference the data from the management frame 214 about the client device 212 against a user profile repository 218. For example, the environment-automation manager 216 may reference a MAC address of the client device 212 against MAC addresses stored in correspondence with user profiles in the user profile repository 218. In this manner, the environment-automation manager 216 may determine the particular user profile in the user profile repository 218 to which the MAC address of the client device 212 corresponds.

The environment-automation manager 216 may configure a setting of an environment-automation device 220. For example, the environment-automation manager 216 may configure the settings of the environment-automation device 220 by sending a command to the environment-automation device 220 to confirm a setting complies with a preference expressed in a user profile corresponding to the client device 212 and/or to adjust operation of the environment-automation device 220 according to a preference expressed in the user profile. For example, the environment-automation device 220 may send a command to the environment-automation device 220 to adjust the smart thermostat to a particular temperature, to switch on lighting via a smart lighting fixture, and to play a personalized greeting via a smart home audio device.

In other examples, the user profiles in the user profile repository 218 may include indications of a user identity corresponding to the client device 212. In such examples, the environment-automation manager 216 may send the indication of the user identity from the user profile to the environment-automation device 220. The environment-automation device 220 may utilize the indication of the user identity to identify a setting, sequence of settings, actions, a sequence of actions of the environment-automation device 220 stored at the environment-automation device 220 in correspondence with the indication of the user identity. The environment-automation device 220 may adjust its settings according to the identified settings, sequence of settings, actions, sequence of actions, etc.

In some examples, the configuration of the settings of the environment-automation device 220 may be triggered by factors or events in addition to receiving the management frame 214 from the client device, extracting the data identifying the client device 212 from the management frame 214, and/or determining a user profile corresponding to the client device 212 from the management frame 214. For example, the physical location of the client device 212 within the environment, the time of day the client device 212 is at the physical location of the environment, the amount of time that the client device 212 is at the physical location, an electronic/visual/audio/or other confirmation or instruction from a user of the client device 212 may be used as triggering events to trigger the configuration of the settings of the environment-automation device 220. Utilizing additional triggering factors or events to trigger the configuration of settings may allow for the configuration to occur at an appropriate time or in appropriate circumstances. For example, additional triggering factors or event may prevent premature configuration of settings before a user of a client device 212 enters their home to experience the environmental effects of the configuration.

An example of a factor or event that may be utilized to trigger a configuration of a setting of an environment-automation device 220 may include a detection of motion, a detection of motion of a particular magnitude, a detection of motion of a particular duration, a detection of motion of a particular velocity, etc. in a portion of the environment where the network device 210 and/or the computing network provide network coverage. For example, the network device 210 may include a motion detector 224. The motion detector 224 may be integrated into the network device 210. The motion detector 224 may be positioned to monitor a portion of the environment for movement. As such, the motion detector 224 may be utilized to determine or approximate a physical location of a user of a client device 212 and/or the client device 212 itself by virtue of the motion generated by its corresponding user moving through the environment.

In such examples, the settings of the environment-automation device 220 may be configured based on the determined user profile and based on a detected physical location of the client device 212. Determining the physical location of the client device 212 may include utilizing a motion detector 224 detecting motion in the portion of the environment. The motion detector 224 may be utilized to identify where a user of a client device is physically located in the environment and may be utilized to synchronize the configuration of the settings of the environment-automation device 220 to the physical location of the user. The motion detector 224 may be integrated with or in direct communication with the network device 210.

Other mechanisms for determining the physical location of the client device 212 may be utilized. For example, the network device 210 may receive relatively short-range radio communications from the client device 212. For example, the network device 210 may receive Bluetooth and/or BLE signals from the client device 212. By virtue of their relatively short-range (e.g. less than three hundred thirty feet) BLE and Bluetooth signals may be indicative of a physical location and/or a proximity of the physical location of the transmitting client device 212 to the receiving network device 210. As such, a motion detected by motion detector 224 may be attributed or corresponded to a client device based on receiving a signal at the network device 210 from the client device 212, wherein the signal (e.g., Bluetooth, BLE, etc.) is a different type of signal than a type of signal corresponding to the management frame (e.g., Wi-Fi radio signal). For example, the different type of signal may have a reduced radio range relative to the signal corresponding to the management frame.

Similarly, signal metrics such as the signal strength, duration of time at a particular signal strength, the signal time of flight, and/or triangulation of a signal received from the client device 212 at the network device 210 and/or a plurality of network devices connected to the same computing network may be utilized to determine the physical location of the client device 212. The signal metrics may be determined from the management frames 214 received from the client device 212. Once the client device 212 has been determined to be at or within a proximity to a particular physical location in the environment, the settings of the environment-automation device 220 may be configured according to the user profile. As such, a motion detected by motion detector 224 may be attributed or corresponded to a client device based on a signal strength corresponding to a management frame sent from the client device 212, a duration of signals received from the client device 212 at a particular signal strength, and/or a triangulation of a point of origin of a signal from the client device 212 based on data from a plurality of network devices, including network device 210, that received the management frame 214.

FIG. 2B illustrates another network device 210 for user profile environment-automation configurations consistent with the disclosure. The network device 210 is not limited to a particular example described herein and may include additional components and/or functionalities such as those described with regard to the system 100 described in FIG. 1, the network device 210 of FIG. 2A, the non-transitory machine-readable medium 334, and the method 450 described in FIG. 4.

An environment-automation device 220 may include devices that may be utilized for security and/or surveillance of the physical environment where the network device 210 and/or the environment-automation device 220 is located. For example, the environment-automation device 220 may include smart security devices such as cameras, alarms, warning systems, etc. that may be used to surveil and/or provide security for an environment such as a home or office building.

As such, the environment-automation manager 216 may be utilized to manage and/or control portions of a security or surveillance system. For example, the user profile repository 218 may include user profiles that specify settings and/or actions of the environment-automation device 220 that are related to security.

For example, a user profile for an unknown user, unknown client device 212, and/or unknown MAC address may be stored in the user profile repository 218. An unknown user, unknown client device 212, and/or unknown MAC address may be a user, client device 212, or MAC address that has not been previously encountered by the network device 210 and/or its connected computing network or one that does not have a specific user profile assigned to it. The environment-automation manager 216 may receive a management frame 214 from an unknown client device 212, such as a client device 212 of a stranger entering a home where a home computing network is set up. Then, prior to associating or authenticating the client device 212 to the network device 210, the environment-automation manger 216 may be able to determine that the client device 212 and/or its user are unknown by referencing the MAC address of the client device 212 against the known MAC addresses corresponding to the user profiles in the user profile repository 218. The environment-automation manager 216 may then configure settings of the smart security devices to record, surveil, identify, trigger an alarm, reorient themselves toward a determined the physical location of, etc. the client device 212.

In this manner, rather than wasting computing resources and memory in surveilling a known family member in a home, the environmental-automation manager may trigger the settings and/or actions of the environment-automation device 220 that are related to security in response to detecting an unknown client device 212 which may indicate the presence of a stranger. Additional triggers such as those described above in relation to determining the physical location of the client device 212 may be utilized in triggering the configuration of settings and/or actions of the environment-automation device 220 that are related to security in response. For example, the network device 210 may detect motion with an integrated motion detector 224. The environment-automation manager 216 may trigger the settings and/or actions responsive to the network device 210 detecting motion with its motion detector 224 portion.

The environment-automation manager 216 may log data related to and from the management frames that the network device 210 receives. For example, the environment-automation manager 216 may log data from the management frame 216 of a client device 212 that uniquely identifies the client device 212. In an example, the MAC address of each client device 212 received by the network device 210 may be logged by the environment-automation manager 216. In addition, the time of day that the management frame 214 was received and/or the duration of the presence of the client device 212 within radio range of the computing network 210 may be logged with the MAC address. Further, the environment-automation device may log, along with the MAC address, any other detections and/or inputs received by the environment-automation devices in the environment during the time the client device 212 was within radio range of the network and/or management frames 214 were being received from the client device 212.

The logged information may be compiled into an activity report 222. The activity report 222 may be transmitted to a network administrator. The network administrator may include the owner of the network, a user of the network, a client device on the network, an IT professional, security staff, etc. The activity report 222 may communicate to the network administrator who was in a physical environment and when they were there. The physical location of the client device 212 within an environment may be determined, logged, and/or included in activity report 222.

The activity report 222 may be periodically sent to the network administrator. The activity report 222 may be pushed to the network administrator at the time that the management frame 214 of the unknown client device 212 was detected. The activity report 222 may be utilized by the network administrator to design and supplement new user profiles for the client device 212.

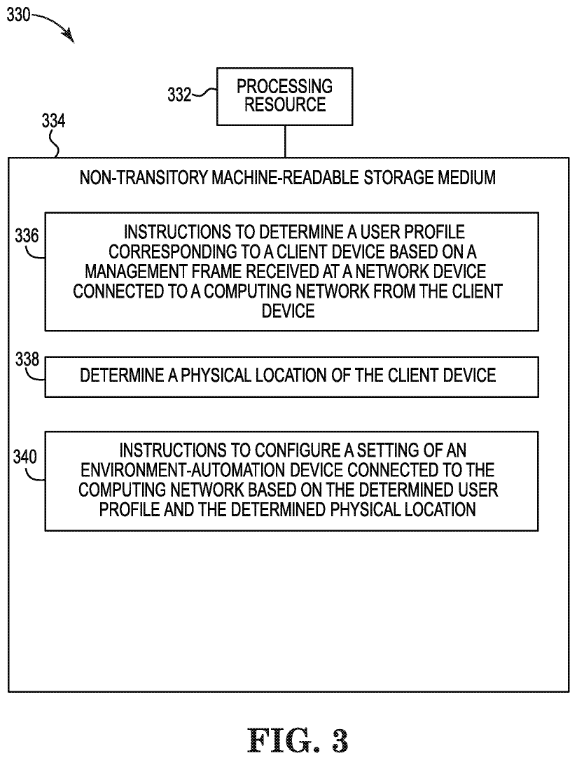

FIG. 3 illustrates a diagram 330 of a processing resource 332 and a non-transitory machine-readable medium 334 for user profile environment-automation configurations consistent with the disclosure. A memory resource, such as the non-transitory machine-readable medium 334, may be used to store instructions (e.g., 336, 338, 340, etc.) executed by the processing resource 332 to perform the operations as described herein. The operations are not limited to a particular example described herein and may include additional operations such as those described with regard to the system 100 described in FIG. 1, the network device 210 of FIGS. 2A and 2B, and the method 450 described in FIG. 4.

A processing resource 332 may execute the instructions stored on the non-transitory machine-readable medium 334. The non-transitory machine-readable medium 334 may be any type of volatile or non-volatile memory or storage, such as random-access memory (RAM), flash memory, read-only memory (ROM), storage volumes, a hard disk, or a combination thereof.

The machine-readable medium 334 may store instructions 336 executable by the processing resource 332 to determine a user profile corresponding to a client device. The corresponding user profile may be determined based on a management frame received, at a network device connected to a computing network, from the client device. The management frame may include data that uniquely identifies the client device whence it was transmitted. For example, the management frame may include data such as a MAC address of the client device.

The management frames may be transmitted from the client device and/or received by a network device such as an access point prior to associating the client device to the access point and/or authenticating the client device to the computing network. For example, the management frames may include probe requests, association requests, authentication requests, etc. that are generated from the client device by virtue of having a corresponding transceiver activated on the client device.

Determining the corresponding user profile may include referencing the data that uniquely identifies the client device in the management frame against a repository of user profiles. Each user profile may correspond to one or more unique identifications of a client device. For example, each user profile stored in a user profile repository may be assigned to at least one MAC address. The assignment of the relationship between a user profile and unique identifications of a client device may be performed by individual clients and/or a network administrator. Once a MAC address is found to match a MAC address corresponding to a user profile, that user profile may be identified as the user profile corresponding to the client device whence the management frame was transmitted.

The user profiles may include instructions and/or preferences for configuring settings of an environment-automation device. For example, the user profiles may include a plurality and/or sequence of actions or settings to be achieved by one or more environment-automation devices to achieve an environmental configuration specified by a client and/or a network administrator. The user profiles may include individual settings or instructions for each of a plurality of environment-automation devices associated with an access point and/or a computing network to which the access point is connected. The settings and/or instructions may be conditional settings and/or instructions. For example, the execution of the settings and/or instructions may rely on triggers such as a time of day, a physical location of the client device, a detection from a sensor in the environment, a current state of conditions within the environment, a day, month, or year, an external data event such as a digital calendar reminder, etc.

The machine-readable medium 334 may store instructions 338 executable by the processing resource 332 to determine a physical location of the client device. Determining a physical location of a client device may include determining the physical location of the client device relative to portions of the environment, other client devices on the computing network, other network devices on the computing network, environment-automation devices on the computing network, zones of the environment where an environment-automation device operates and/or influences environmental conditions.

Determining a physical location of the client device may include determining the physical location of the client device based on motion detections reported by motion detectors present in the environment and/or integrated with network devices providing wireless network coverage. When a motion is detected by a sensor in the environment, the physical location of that detection may be determined from the detection and associated with the client device that transmitted the management frame detected by the network device.

Determining a physical location of the client device may utilize relatively short range or relatively low power signals exchanged between the client device and a network device, other client device, and/or environment-automation device on the client network to establish a physical location. For example, by utilizing Bluetooth and/or BLE signal reception from the client device at a network device, the physical location of the client device may be determined. For example, a proximity of the client device to a network device, other client device, and/or environment-automation device on the client network with a known location relative to the environment may be established when one of these types of signals is received from the client device.

Determining a physical location of the client device may also be achieved by analysis of signal time of flight, signal strength, signal dwell time, signal dwell time at a particular strength, triangulation based on signals, etc. The data to perform these analyses may be extracted from the management frame and/or from additional signals exchanged between the client device and the network device or network devices of the computing network.

The machine-readable medium 334 may store instructions 340 executable by the processing resource 332 to configure a setting of an environment-automation device connected to the computing network of the network device. Configuring the setting may include adjusting the environment-automation device to condition the environment to achieve preferences expressed in a user profile. For example, configuring the settings may include adjusting the temperature on a smart thermostat, playing audio over a smart speaker system, adjusting the lighting conditions with a smart lighting system, reorienting and/or initiating tracking or recording by smart surveillance devices.

The settings of the environment-automation device may be configured based on the user profile. As described above, the user profile may include instructions, commands, preferences, etc. that may be translated into actions executable by the environment-automation devices to condition the physical environment accordingly. For example, the contents of the user profile may be utilized to trigger mechanical action, electronic action, auditory instantiation, visual instantiation, environment ambiance adjustment, and/or environment climate adjustment that is perceptible or imperceptible by a user corresponding to the client device.

Additionally, the settings of the environment-automation device may be configured based on the determined physical location. For example, the determination that the client device is at a physical location may be utilized to time the triggering of the settings configuration of the environment-automation device. Additionally, the preferences or instructions in the user profile may be conditional upon particular physical locations such that a determined physical location is utilized to determine and/or select particular ones of the preferences and/or instructions that will be utilized to execute the settings configuration. For example, when the user associated with a client device and/or the client device are located in the living room portion of the home then audio data should be played through speakers in the living room, whereas when the user associated with a client device and/or the client device are located in the backyard of the home then the audio data should be played through the outdoor speakers at the rear of the home.

Other events or conditions may be utilized to trigger the settings configurations and/or to select the particular settings configurations to be executed from a user profile. For example, the time of day, date, month, season, historical absence of the client device, historical presence of the client device, outdoor weather conditions, interior climate conditions, data from other sensors, etc. may be utilized to trigger the settings configurations and/or to select the particular settings configurations to be executed from the settings configurations stored in a user profile corresponding to the client device.

As described above, the various detections, the timing of the detections, and the determinations based on those detections may be compiled into an activity report. The activity report may be communicated to and/or accessible by a network administrator and/or client device. The activity report may provide a log of who was in an environment, when they were in the environment, and the actions that the took in the environment, all without associating a user to an access point and/or authenticating the user to the computing network. In this manner, a user of a client device may not pass undetected through an environment and/or manually manipulate an environment without creating a record simply by not associating to an access point or joining a computing network. Instead, details about the user's presence and/or actions in an environment may be logged and/or reported as a consequence of the user having their client device, such as the ubiquitous smartphone, with them. For example, a network administrator is able to determine that the smartphone of a user was present in an environment where the network devices are located and when it was there based on the MAC address of the smartphone being detected from a management frame at a particular time.

FIG. 4 illustrates a diagram of a method 450 for user profile environment-automation configurations consistent with the disclosure. The method 450 is not limited to a particular example described herein and may include additional components and/or functionalities such as those described with regard to the system 100 described in FIG. 1, the network device 210 of FIG. 2A, the network device 210 of FIG. 2B, and the non-transitory machine-readable medium 334.

At 452, the method 450 may include detecting, at a network device connected to a computing network, a management frame transmitted from a client device. In some examples, the network device may detect a plurality of management frames, where each management frame of the plurality of management frames is transmitted from a different client device of a plurality of client devices.

In some examples, an environment such as a home or office building may be occupied by more than a single user and/or more than a single client device. As such, a network device in one of these types of environments may receive a plurality of management frames.

The management frames may include information that identifies the client device transmitting it. For example, a management frame may include a unique identifier such as a MAC address of a client device. Additionally, a management frame may include an identification of a type of a client device (e.g., smartphone, wearable smart device, tablet, laptop, desktop, smartwatch, etc.). The management frame may be a frame that is transmitted by the client device when a corresponding transceiver is active on the client device and in advance of the client device associating to a network device and/or a computing network.

At 454, the method 450 may include determining a user profile associated with a client device. In examples where a plurality of client devices was detected from a plurality of management frames received by a network device, a user profile corresponding to each of the plurality of client devices may be determined. As described above, the user profile corresponding to a client device may be determined by referencing data from each management frame that identifies the client device against stored client device identifying data that is assigned to a user profile and/or to a default user profile. As such, the user profile that corresponds to a client device may be identified by data extracted from the management frame sent from that client device.

At 456, the method 450 may include triggering a sequence of environment-automation device settings configurations for an environment-automation device connected in communication with a network device where the management frame was received from the client device. The sequence of setting configurations to be triggered may be determined may be determined based on the user profile corresponding to a client device of the plurality of client devices from which a management frame was received.

For example, where a plurality of management frames transmitted form a plurality of client devices is received at a network device, a plurality of user profiles may be identified as being assigned to the unique identifier of their respective client devices. Each of the plurality of user profiles may include preferences, instructions, commands, etc. that specify setting configurations to occur when the client device is detected in the environment. In some examples, the plurality of user profiles may include conflicting and/or mutually exclusive settings configurations.

Determining the sequence of setting configurations may include prioritizing setting configurations that correspond to different user profiles and/or different client devices simultaneously detected in the environment. For example, determining the sequence of setting configurations may include prioritizing settings configurations corresponding to a first user profile detected in the environment over settings configurations corresponding to a second user profile detected in the environment. For example, a parent in a home, a manager in a business, a senior employee in a business, etc. whose user profile is determined to correspond to a client device detected in the environment may have their setting configurations from their user profile executed in advance of or in place of a child in a home, an employee in a business, a junior employee in a business, etc. whose user profile is determined to correspond to a client device simultaneously detected in the environment.

Determining the sequence of setting configurations may include selecting a subset of the sequence of settings configurations present in the plurality of user profiles corresponding to the plurality of client devices detected in the environment. In some examples, the subset of the settings configurations may be a subset of setting configurations shared in common between the plurality of user profiles. For example, if a first user profile corresponding to a first client device detected in the environment specifies a smart thermostat should be set to seventy degrees Fahrenheit and a second user profile corresponding to a second client device also specifies a smart thermostat should be set to seventy degrees Fahrenheit, then the smart thermostat may be triggered to adjust the temperature in the environment to seventy degrees Fahrenheit.

However, if the first user profile specifies to play a classical music selection on a smart speaker and the second user profile specifies to play a rap music selection on a smart speaker, a conflict may be detected, and no song may be played. In some examples, a compromise between setting configurations between profiles may be triggered. For example, where the first user profile specifies a smart thermostat should be set to seventy degrees Fahrenheit and a second user profile corresponding to a second client device specifies the smart thermostat should be set to seventy-two degrees Fahrenheit, then the smart thermostat may be triggered to adjust the temperature in the environment to seventy-one degrees Fahrenheit.

The sequence of environment-automation configurations for the environment-automation device may be triggered by a triggering event. For example, the sequence of environment-automation configurations for the environment-automation device may be triggered in response to a motion detector integrated into the access point detecting a motion in the environment. The detection of the motion by the access point that received the management frame may serve as confirmation that a user of a client device is present in the environment and has not just left their client device in the environment. Upon detecting the motion, the access point may trigger the execution by the environment-automation device of the setting configurations.

In the foregoing detailed description of the present disclosure, reference is made to the accompanying drawings that form a part hereof, and in which is shown by way of illustration how examples of the disclosure may be practiced. These examples are described in sufficient detail to enable those of ordinary skill in the art to practice the examples of this disclosure, and it is to be understood that other examples may be utilized and that process, electrical, and/or structural changes may be made without departing from the scope of the present disclosure.

The figures herein follow a numbering convention in which the first digit corresponds to the drawing figure number and the remaining digits identify an element or component in the drawing. Elements shown in the various figures herein can be added, exchanged, and/or eliminated so as to provide a plurality of additional examples of the present disclosure. In addition, the proportion and the relative scale of the elements provided in the figures are intended to illustrate the examples of the present disclosure, and should not be taken in a limiting sense.

What is claimed:

1. A system comprising:
a processing resource;
a computing device, connected to a computing network, comprising instructions executable by the processing resource to:
determine, from a network management frame received by a network device from a client device, a user profile corresponding to the client device; and
configure, responsive to detecting a motion with the network device, a setting of an environment-automation device connected to the computing network based on the determined user profile.

2. The system of claim 1, wherein the network management frame is a probe request frame.

3. The system of claim 1, wherein the network management frame is an association request frame.

4. The system of claim 1, including instructions executable by the processing resource to determine the user profile associated with the client device from a media access control address (MAC address) of the client device included in the network management frame.

5. The system of claim 1, including instructions executable by the processing resource to identify a setting configuration preference stored in the user profile.

6. The system of claim 5, including instructions executable by the processing resource to configure the setting of the environmental-automation device according to the setting configuration preference stored in the user profile.

7. The system of claim 1, wherein the network device comprises an access point with an integrated motion detecting sensor.

8. The system of claim 1, including instructions executable by the processing resource to select a portion of setting configurations from the user profile to configure based on a time of day that the management frame is received.

9. The system of claim 1, including instructions executable by the processing resource to select a portion of setting configurations from the user profile to configure based on a device type corresponding to the client device.

10. The system of claim 1, wherein the network management frame is received from the client device prior to an association of the client device to the computing network.

11. A non-transitory machine-readable medium storing instructions executable by a processing resource to:
determine a user profile corresponding to a client device based on a management frame received at a network device connected to a computing network from the client device;
determine a physical location of the client device based on a motion detected by the network device; and
configure a setting of an environment-automation device connected to the computing network based on the determined user profile and the determined physical location.

12. The non-transitory machine-readable medium of claim 11, wherein the instructions to determine the physical location of the client device determine the physical location based on a physical orientation of the network device that detected the motion.

13. The non-transitory machine-readable medium of claim 11, including instructions to correspond the detected motion to a client device based on a signal strength of the client device included in the management frame.

14. The non-transitory machine-readable medium of claim 11, including instructions to correspond the detected motion to a client device based on a duration of a signal strength of the client device.

15. The non-transitory machine-readable medium of claim 11, including instructions to correspond the detected motion to a client device based on a triangulation of a point of origin of a signal from the client device based on data from a plurality of network devices, including the network device, that received the management frame.

16. The non-transitory machine-readable medium of claim 11, including instructions executable by the processing resource to report, to a network administrator, data from the management frame that uniquely identifies the client device and a time the management frame was received.

17. The non-transitory machine-readable medium of claim 11, including instructions to correspond the detected motion to a client device based on receiving a signal at the network device from the client device, wherein the signal is a different type of signal than a type of signal corresponding to the management frame.

18. A method, comprising:
detecting, at a network device connected to a computing network, a management frame transmitted from each client device of a plurality of client devices;
determining a user profile corresponding to each client device of the plurality of client devices;
triggering, responsive to detecting a motion with the network device, a sequence of environment-automation device setting configurations for an environment-automation device in communication with the network device, wherein the sequence of setting configurations is determined based on the user profile corresponding to each client device of the plurality of client devices.

19. The method of claim 18, wherein determining the sequence of setting configurations includes prioritizing setting configurations corresponding to a first user profile over setting configurations corresponding to a second user profile.

20. The method of claim 18, wherein determining the sequence of setting configurations includes selecting a subset of the sequence of setting configurations, wherein the subset is setting configurations in common between the first user profile and the second user profile.
